(19) United States
(12) Patent Application Publication
(10) Pub. No.: US 2026/0239136 A1
(43) Pub. Date: Aug. 13, 2026

(54) METHOD AND DEVICE FOR CARRIER AGGREGATION USING SYNCHRONIZATION SIGNAL BLOCK-LESS CELL IN NEXT-GENERATION MOBILE COMMUNICATION SYSTEM

(71) Applicant: Samsung Electronics Co., Ltd., Suwon-si, Gyeonggi-do (KR)

(72) Inventors: June HWANG, Suwon-si (KR); Anil AGIWAL, Suwon-si (KR); Jaehyuk JANG, Suwon-si (KR)

(21) Appl. No.: 19/155,797

(22) PCT Filed: Feb. 16, 2024
(86) PCT No.: PCT/KR2024/095264

§ 371 Date: Aug. 12, 2025

(30) Foreign Application Priority Data
Feb. 16, 2023 (KR) 10-2023-0020849

(51) Int. Cl. H04W 36/08; H04W 56/00; H04W 76/20

(52) U.S. Cl. CPC H04W 36/08; H04W 56/0015; H04W 76/20

(57) ABSTRACT

The present disclosure relates to a 5G or 6G communication system for supporting a higher data transmission rate. A method of a terminal in a wireless communication system according to an embodiment of the present disclosure may comprise the steps of: receiving, from a base station, an RRC message including downlink frequency information corresponding to a secondary cell (Scell) and information indicating addition of the Scell corresponding to a synchronization signal block (SSB)-less Scell which does not transmit an SSBB, wherein the downlink frequency information does not include a field indicating an absolute frequency of the SSB and includes a field indicating a reference cell for time synchronization of the Scell; and acquiring a timing reference of the Scell on the basis of the reference cell.

### TECHNICAL FIELD

This technology relates to an operation of a terminal in a mobile communication system and, more specifically, to a method and a device for frequency aggregation using a synchronization signal block (SSB)-less secondary cell (SBB-less Scell).

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### DISCLOSURE OF INVENTION

### Technical Problem

The disclosure provides a method and a device for frequency aggregation using an SSB-less Scell.

### Solution to Problem

A method of a terminal in a wireless communication system according to an embodiment of the disclosure may include: receiving, from a base station, an RRC message including information indicating addition of a secondary cell (Scell), which is a synchronization signal block (SSB)-less Scell which does not transmit an SSB, and downlink frequency information corresponding to the Scell, the downlink frequency information not including a field indicating an absolute frequency of an SSB and including a field indicating a reference cell for time synchronization of the Scell; and based on the reference cell, acquiring a timing reference of the Scell.

### Advantageous Effects of Invention

Various embodiments of the disclosure can provide an apparatus and a method capable of effectively providing services in a mobile communication system.

### BRIEF DESCRIPTION OF DRAWINGS

FIG. 1 illustrates a structure of a typical LTE system.

FIG. 2 illustrates a radio protocol structure of a typical LTE system;

FIG. 3 illustrates a structure of a next-generation mobile communication system according to an embodiment of the disclosure.

FIG. 4 illustrates a radio protocol structure of a next-generation mobile communication system according to an embodiment of the disclosure.

FIG. 5 is a block diagram illustrating an internal structure of a UE according to an embodiment of the disclosure.

FIG. 6 is a block diagram illustrating a structure of an NR base station according to an embodiment of the disclosure.

FIG. 7 is a diagram illustrating a method of adding an SSB-less Scell;

FIG. 8 is a diagram illustrating a method of performing time synchronization for an SSB-less Scell by using a non-serving cell when adding the SSB-less Scell according to an embodiment of the disclosure;

FIG. 9 is a diagram illustrating a method of using information on a serving cell as measurement information of an SSB-less Scell and using an index on the serving cell when adding the SSB-less Scell according to an embodiment of the disclosure;

FIG. 10 is a diagram illustrating a method of using information on a non-serving cell as measurement information of an SSB-less Scell and using an index on a serving cell or information on the non-serving cell when adding the SSB-less Scell according to an embodiment of the disclosure;

FIG. 11 is a diagram illustrating a method of transferring alternative cell information along with a deactivation RRC message or MAC CE when a synchronization reference is deactivated after adding an Scell according to an embodiment of the disclosure; and

FIG. 12 is a diagram illustrating a method of transferring alternative synchronization source cell information simultaneously with Scell addition according to one embodiment of the disclosure.

### BEST MODE FOR CARRYING OUT THE INVENTION

A method of a UE in a wireless communication system according to an embodiment of the disclosure may include: receiving, from a base station, an RRC message including information indicating addition of a secondary cell (Scell), which is a synchronization signal block (SSB)-less Scell which does not transmit an SSB, and downlink frequency information corresponding to the Scell, wherein the downlink frequency information does not include a field indicating an absolute frequency of an SSB, and includes a field indicating a reference cell for time synchronization of the Scell; and based on the reference cell, acquiring a timing reference of the Scell.

In an embodiment, the method may further include, if the downlink frequency information does not include the field indicating the reference cell, acquiring the timing reference of the Scell based on a preconfigured cell.

In an embodiment, the Scell and the reference cell may support inter-band carrier aggregation (CA).

In an embodiment, the reference cell may include an Scell that transmits an SSB.

In an embodiment, the reference cell may be included in the same cell group as that of the Scell.

A method of a base station in a wireless communication system according to an embodiment of the disclosure may include: identifying a reference cell for time synchronization of a secondary cell (Scell) that is a synchronization signal block (SSB)-less Scell which does not transmit an SSB; and transmitting, to a UE, an RRC message including information indicating addition of the Scell and downlink frequency information corresponding to the Scell, wherein the downlink frequency information does not include a field indicating an absolute frequency of an SSB, and includes a field indicating the reference cell.

In an embodiment, the Scell and the reference cell may support inter-band carrier aggregation (CA).

In an embodiment, the reference cell may be included in the same cell group as that of the Scell, and include an Scell that transmits an SSB.

A UE of a wireless communication system according to an embodiment of the disclosure may include a transceiver, and a processor connected to the transceiver, wherein the processor is configured to: receive, from a base station, an RRC message including information indicating addition of a secondary cell (Scell), which is a synchronization signal block (SSB)-less Scell which does not transmit an SSB, and downlink frequency information corresponding to the Scell, wherein the downlink frequency information does not include a field indicating an absolute frequency of an SSB, and includes a field indicating a reference cell for time synchronization of the Scell; and based on the reference cell, acquire a timing reference of the Scell.

In an embodiment, the processor may be configured to, if the downlink frequency information does not include the field indicating the reference cell, acquire the timing reference of the Scell based on a preconfigured cell.

In an embodiment, the Scell and the reference cell may support inter-band carrier aggregation (CA).

In an embodiment, the reference cell may include an Scell that transmits an SSB.

A base station of a wireless communication system according to an embodiment of the disclosure may include a transceiver, and a processor connected to the transceiver, wherein the processor is configured to: identify a reference cell for time synchronization of a secondary cell (Scell) that is a synchronization signal block (SSB)-less Scell which does not transmit an SSB; and transmit, to a UE, an RRC message including information indicating addition of the Scell and downlink frequency information corresponding to the Scell, wherein the downlink frequency information does not include a field indicating an absolute frequency of an SSB, and includes a field indicating the reference cell.

In an embodiment, the Scell and the reference cell may support inter-band carrier aggregation (CA).

In an embodiment, the reference cell may be included in the same cell group as that of the Scell, and include an Scell that transmits an SSB.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the base station and the terminal are not limited to the above examples. In the disclosure, a “downlink (DL)” refers to a radio link via which a base station transmits a signal to a terminal, and an “uplink (UL)” refers to a radio link via which a terminal transmits a signal to a base station.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

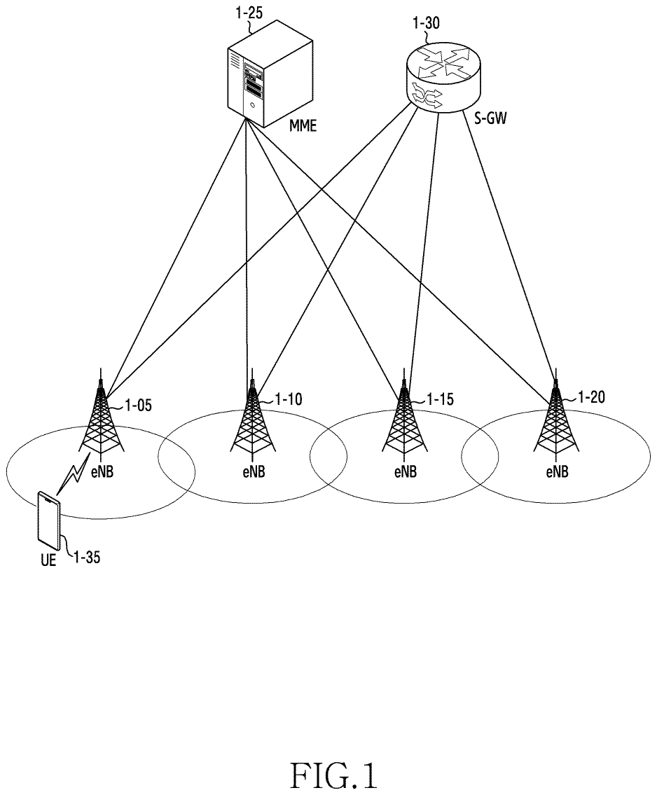

When performing frequency aggregation for a cell transmitting no synchronization signal, information on an alternative cell, which can be used as a synchronization signal, is not provided to a UE. In an embodiment, a UE may recognize another cell that provides a synchronization signal, add an Scell based on the synchronization signal of the other cell, and perform a frequency aggregation operation. FIG. 1 illustrates a structure of a typical LTE system.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05 to 1-20 and the S-GW 1-30.

In FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over IP (VOIP) via the Internet protocol, may be serviced through a shared channel. Thus, a device that collects state information, such as buffer states, available transmit power states, and channel states of UEs, and performs scheduling accordingly is required, and the ENBs 1-05 to 1-20 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE. The S-GW 1-30 is a device that provides a data bearer, and may generate or remove a data bearer under the control of the MME 1-25. The MME is a device responsible for various control functions as well as a mobility management function for a UE, and may be connected to multiple base stations.

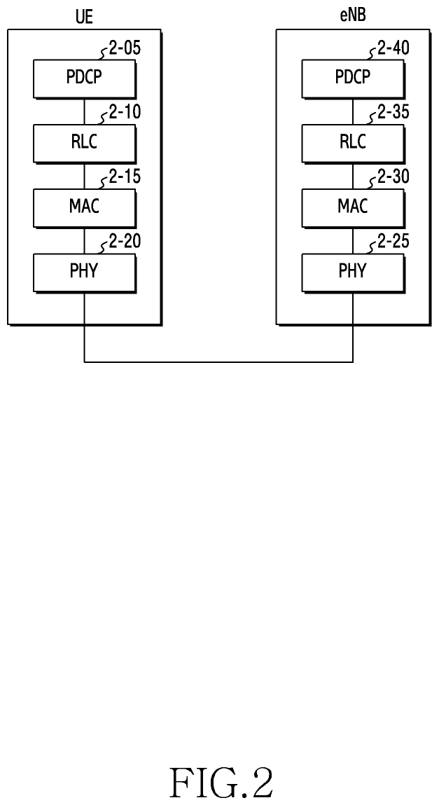

FIG. 2 illustrates a radio protocol structure of a conventional LTE.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 on each of UE and ENB sides. The PDCP may serve to perform operations such as IP header compression/reconstruction. The main functions of the PDCP may be summarized as follows. The PDCP is not limited by the following exemplary functions and may perform various functions.
Header compression and decompression: robust header compression (ROHC) only
Transfer of user data
In-sequence delivery (In-sequence delivery of upper layer PDUs at PDCP re-establishment procedure for RLC AM)
For split bearers in dual connectivity (DC) (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) into an appropriate size to perform an automatic repeat request (ARQ) operation. The main functions of the RLC may be summarized as follows. The RLC is not limited by the following exemplary functions and may perform various functions.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC are summarized as follows. The MAC is not limited by the following exemplary functions and may perform various functions.
Mapping between logical channels and transport channels
Multiplexing/demultiplexing of MAC SDUs belonging to one or different logical channels into/from transport blocks (TB) delivered to/from the physical layer on transport channels
Scheduling information reporting
HARQ (Error correction through HARQ)
Priority handling between logical channels of one UE
Priority handling between UEs by means of dynamic scheduling
   Multimedia broadcast and multicast service (MBMS) service identification
Transport format selection
Padding

A physical (PHY) layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The physical layer is not limited by these exemplary functions and may perform various functions.

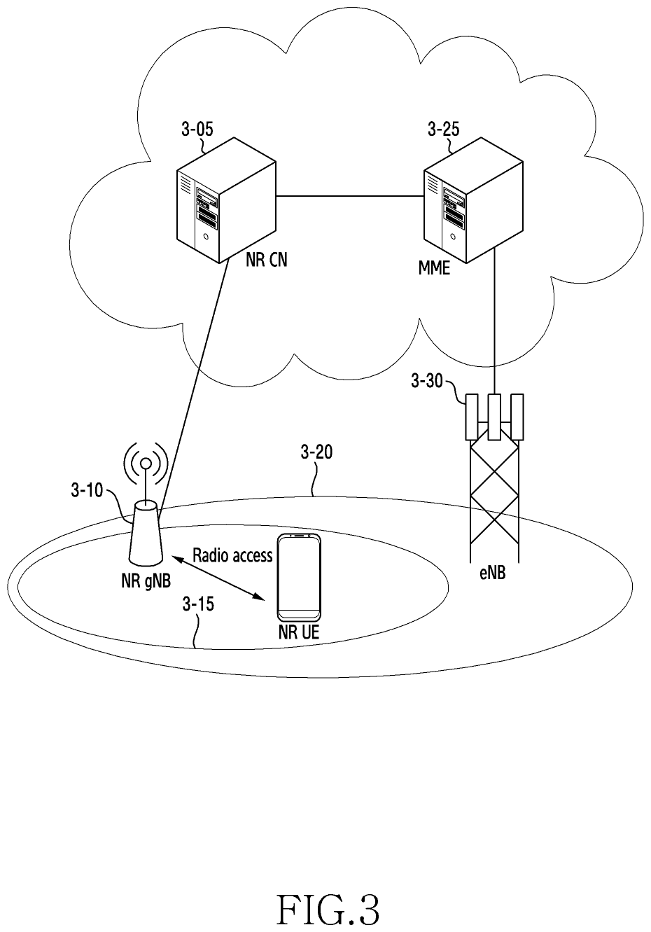

FIG. 3 illustrates a structure of a next-generation mobile communication system.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved node B (eNB) of a conventional LTE system. The NR gNB may be connected to the NR UE 3-15 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR NB 3-10 may serve as the device. In general, one NR gNB may control multiple cells. In order to implement ultrahigh-speed data transfer beyond the current LTE, the next-generation mobile communication system may employ a wider bandwidth than the existing maximum bandwidth. in addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 3-05 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN 3-05 may be connected to an MME 3-25 via a network interface. The MME may be connected to an eNB 3-30 that is an LTE base station.

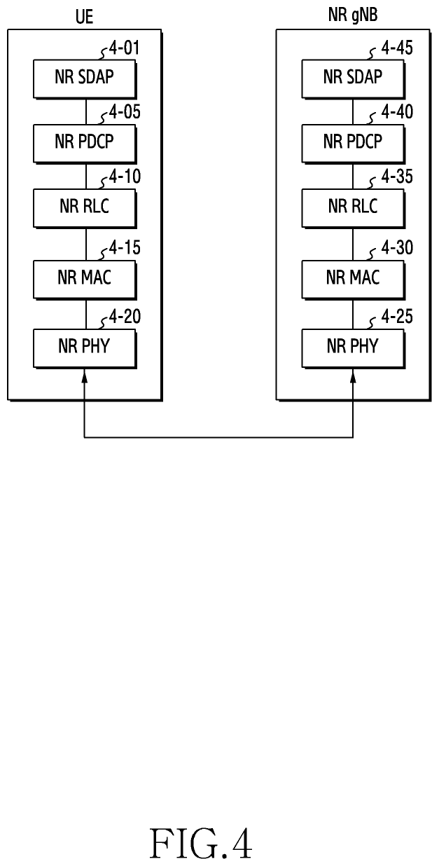

FIG. 4 illustrates a radio protocol structure of a next-generation mobile communication system to which the disclosure is applicable.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 on each of UE and NR base station sides.

The main functions of the NR SDAP 4-01 or 4-45 may include some of functions below. The NR SDAP is not limited by the following exemplary functions and may perform various functions.
Transfer of user plane data
Mapping between a QoS flow and a data bearer for uplink and downlink (mapping between a QoS flow and a DRB for both DL and UL)
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 4-05 or 4-40 may include some of functions below. The NR PDCP is not limited by the following exemplary functions and may perform various functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink
   The reordering of the NR PDCP device may refer to a function of reordering PDCP PDUs received from a lower layer in an order based on PDCP sequence numbers (SNs). The reordering of the NR PDCP device may include a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

The main functions of the NR RLC 4-10 or 4-35 may include some of functions below. The NR RLC is not limited by the following exemplary functions and may perform various functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may refer to a function of successively delivering RLC SDUs received from the lower layer to the upper layer. If one original RLC SDU is divided into several RLC SDUs and the RLC SDUs are received, the in-sequence delivery function of the NR RLC device may include a function of reassembling the several RLC SDUs and transferring the reassembled RLC SDUs.

The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

The in-sequence delivery of the NR RLC device may refer to a function of, if there is a lost RLC PDU, delivering only RLC SDUs before the lost RLC PDU to the upper layer in sequence.

The in-sequence delivery of the NR RLC device may include a function of, although there is a lost RLC SDU, if a predetermined timer has expired, sequentially transferring, to the upper layer, all the RLC SDUs received before the timer is started.

The in-sequence delivery of the NR RLC device may include a function of, although there is a lost RLC SDU, if a predetermined timer has expired, sequentially transferring all the RLC SDUs received up to now, to the upper layer.

The NR RLC device may process RLC PDUs in a reception sequence, regardless of a sequence based on sequence numbers (out-of-sequence delivery). and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include a concatenation function, but the concatenation function may be performed in the NR MAC layer or replaced with a multiplexing function of the NR MAC layer.

The out-of-sequence delivery of the NR RLC device 1035 or 1060 may refer to a function of directly delivering RLC SDUs, received from the lower layer, to the upper layer regardless of the sequence. The out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging order to record lost RLC PDUs.

The NR MAC 14-15 or 4-30 may be connected to multiple NR RLC layer devices configured in one UE, and the main functions of the NR MAC may include some of functions below. The NR MAC is not limited by the following exemplary functions and may perform various functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR physical (PHY) layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The NR PHY layer is not limited by these exemplary functions and may perform various functions.

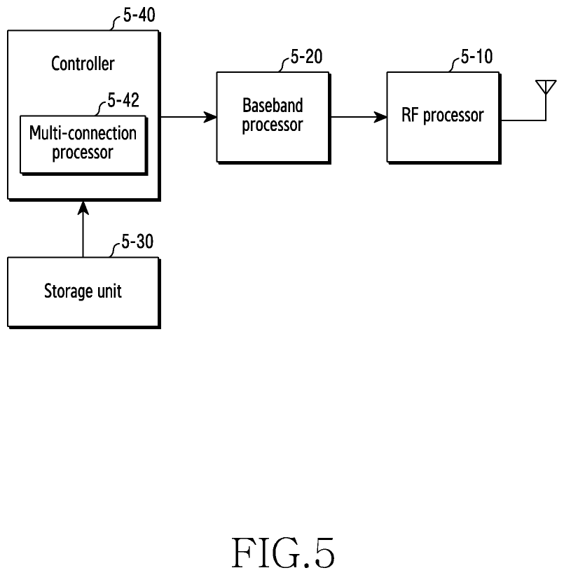

FIG. 5 is a block diagram illustrating an internal structure of a UE according to an embodiment of the disclosure.

Referring to FIG. 5, the UE may include a radio frequency (RF) processor 5-10, a baseband processor 5-20, a storage unit 5-30, and a controller 5-40.

The RF processor 5-10 may perform a function for transmitting and receiving a signal via a wireless channel, such as band conversion and amplification of the signal. That is, the RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), and the like. Although only one antenna is illustrated in FIG. 5, the UE may include multiple antennas. In addition, the RF processor 5-10 may include multiple RF chains. Furthermore, the RF processor 5-10 may perform beamforming. For the beamforming, the RF processor 5-10 may adjust the phase and magnitude of each of signals transmitted and received through multiple antennas or antenna elements. In addition, the RF processor 5-10 may perform multiple input multiple output (MIMO), and may receive multiple layers when performing MIMO operations.

The baseband processor 5-20 may perform functions of conversion between baseband signals and bitstrings according to the system's physical layer specifications. For example, during data transmission, the baseband processor 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the orthogonal frequency division multiplexing (OFDM) scheme, during data transmission, the baseband processor 5-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

The baseband processor 5-20 and the RF processor 5-10 may transmit and receive signals as described above. Therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GHz) bands. The UE may transmit/receive signals to/from the base station by using the baseband processor 5-20 and the RF processor 5-10. The signals may include control information and data.

The storage unit 5-30 stores data such as basic programs, application programs, and configuration information for operations of the UE. Particularly, the storage unit 5-30 may store information regarding a second access node configured to perform wireless communication by using a second radio access technology. In addition, the storage unit 5-30 provides the stored data at the request of the controller 5-40.

The controller 5-40 controls the overall operation of the UE. For example, the controller 5-40 may transmit/receive signals through the baseband processor 5-20 and the RF processor 5-10. In addition, the controller 5-40 records data in the storage unit 5-30 and reads the data from the storage unit 5-30. To this end, the controller 5-40 may include at least one processor. For example, the controller 5-40 may include a communication processor (CP) configured to perform control for communication, and an application processor (AP) configured to control upper layers such as application programs.

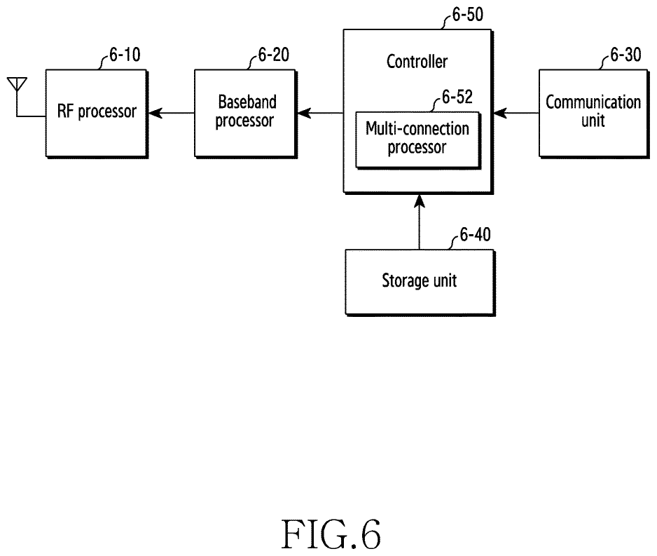

FIG. 6 is a block diagram illustrating a structure of an NR base station according to an embodiment of the disclosure.

Referring to FIG. 6, the base station may include an RF processor 6-10, a baseband processor 6-20, a backhaul communication unit 6-30, a storage unit 6-40, and a controller 6-50.

The RF processor 6-10 may perform a function for transmitting and receiving a signal via a wireless channel, such as band conversion and amplification of the signal. That is, the RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in FIG. 6, the base station may include multiple antennas. In addition, the RF processor 6-10 may include multiple RF chains. Furthermore, the RF processor 6-10 may perform beamforming. For the beamforming, the RF processor 6-10 may adjust the phase and magnitude of each of signals transmitted and received through multiple antennas or antenna elements. The RF processor may transmit one or more layers to perform a downward MIMO operation.

The baseband processor 6-20 may perform functions of conversion between baseband signals and bitstrings according to the physical layer specifications of first radio access technology. For example, during data transmission, the baseband processor 6-20 may encode and modulate a transmitted bitstring to generate complex symbols. In addition, during data reception, the baseband processing unit 6-20 may demodulate and decode a baseband signal provided from the RF processing unit 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through an IFFT operation and CP insertion. In addition, on receiving data, the baseband processor 6-20 may divide the baseband signal provided from the RF processor 6-10 into units of OFDM symbols, restore signals mapped to subcarriers via the FFT operation, and then restore a received bit stream via demodulation and decoding. The baseband processor 6-20 and the RF processor 6-10 may transmit and receive signals as described above. Therefore, the baseband processor 6-20 and the RF processor 6-10 may be referred to as a transmitter, a receiver, a transceiver, a communication unit, or a wireless communication unit. The base station may transmit/receive signals to/from the UE by using the baseband processor 6-20 and the RF processor 6-10. The signals may include control information and data.

The backhaul communication unit 6-30 may provide an interface for communicating with other nodes in the network. That is, the backhaul communication unit 6-30 may convert bitstrings transmitted from the main base station to other nodes (for example, auxiliary base station, core network) to physical signals, and may convert physical signals received from the other nodes to bitstrings.

The storage unit 6-40 stores data such as basic programs, application programs, and configuration information for operations of the base station. In particular, the storage unit 6-40 may store information on bearers allocated to the connected UE, measurement results reported from the connected UE, and the like. In addition, the storage unit 6-40 may store information serving as a reference to determine whether to provide multi-connection to a UE or to suspend the same. In addition, the storage unit 6-40 provides stored data at the request of the controller 6-50.

The controller 6-50 controls the overall operation of the base station. For example, the controller 6-50 may transmit/receive signals through the baseband processor 6-20 and the RF processor 6-10 or through the backhaul communication unit 6-30. In addition, the controller 6-50 records data in the storage unit 6-40 and reads the data from the storage unit 6-40. To this end, the controller 6-50 may include at least one processor.

The disclosure is to solve a problem that occurs when a cell which does not transmit an SSB is considered as an Scell in inter-band CA. Accordingly, solutions for the following three cases are proposed.
When measuring an SSB-less Scell, extending a reference cell, which provides time synchronization, to a non-serving cell
When adding the measured SSB-less Scell, there is no absoluteFrequencySSB information on frequencyInfoDL of the corresponding Scell. In this case, the Scell being a source of time synchronization is expressed.
After the SSB-less Scell is added, if a corresponding time/frequency synchronization reference cell is deactivated, a cell that needs to be referenced for L1/L3 measurement is presented.
When the UE receives a measurement configuration for a specific cell from a network, the network may transfer the following information to the UE in order to perform measurement on the cell which does not transmit an SSB.
Measurement Object (MO)
CSI-RS measurement resource information associated with the MO
   The CSI-RS measurement resource information includes CSI-RSs transmitted by cells associated with the MO.
   Sol 1: For each of the CSI-RS transmission cells, a specific serving cell may correspond to cell information for time synchronization of each CSI-RS resource of each CSI-RS cell. If this specific serving cell is given to the UE by using an index of one serving cell among existing serving cells, the CSI-RS measurement resource information may include slot offset information obtained by considering inter-band CA between the cell and the CSI-RS transmission cell. Here, a slot offset is a time mismatch value at frame boundary misalignment in inter-band carrier aggregation where slots are aligned and SFNs are partially aligned, and includes a slot offset between the synchronization source cell and the CSI-RS cell. (Slot offset between the synch source cell and the CSI-RS Cell in unaligned frame boundary with slot alignment and partial SFN alignment inter-band CA)
   Sol 2-1: For each CSI-RS cell, non-serving cell information may be included as a time synchronization cell for CSI-RS measurement. In this case, if there is no associatedSSB information for each CSI-RS resource, the time synchronization cell is referenced.
      The time synchronization cell information may include a physical cell identity (PCI) of the cell and/or a downlink (DL) frequency of the cell, i.e., absolute radio frequency channel number (ARFCN) and/or NR cell global identity (NCGI) information, for recognizing the cell.
      The time synchronization cell information may include information indicating, at a slot level, a time difference between the time synchronization cell and the CSI-RS transmission cell. A slot offset is a time mismatch value at frame boundary misalignment in inter-band carrier aggregation where slots are aligned and SFNs are partially aligned, and includes a slot offset between the synchronization source cell and the CSI-RS cell. (Slot offset between the synch source cell and the CSI-RS Cell in unaligned frame boundary with slot alignment and partial SFN alignment inter-band CA)
      Ca-slotOffset information may be an offset based on the number of slots, a time value based on msec, or an offset value based on the number of symbols. The Ca-slotOffset information may include an indicator indicating to increase or decrease a time for a target cell (a cell to be added or a cell subject to CSI-RS measurement) based on the synchronization source cell. For example, + may mean increase, and − may indicate to decrease, but + and − may have the opposite meanings. Alternatively, additionally, the slot offset may be determined in the following manner.

The slot offset includes a slot offset between the synchronization source cell and the CSI-RS cell in unaligned frame boundary with inter-band CA where slots are aligned and SFNs are partially aligned. Based on this field, the UE determines the time offset of the Scell as specified in clause 4.5 of TS 38.211[16]. A granularity of this field is determined by a reference subcarrier spacing (SCS) for the slot offset. (i.e., the maximum value of the lowest SCS of the synchronization source cell among all configured SCSs in DL/UL SCS-SpecificCarrierList within ServingCellConfigCommon or ServingCellConfigCommonSIB, and the lowest SCS of this serving cell (i.e., the target Scell) among all configured SCSs in DL/UL SCS-SpecificCarrierList within ServingCellConfigCommon or ServingCellConfigCommonSIB) (Slot offset between the target Scell and synch source(S) Cell in unaligned frame boundary with slot alignment and partial SFN alignment inter-band CA. Based on this field, the UE determines the time offset of the Scell as specified in clause 4.5 of TS 38.211 [16]. The granularity of this field is determined by the reference SCS for the slot offset (i.e., the maximum of synch source cell's lowest SCS among all the configured SCSs in DL/UL SCS-SpecificCarrierList in ServingCellConfigCommon or ServingCellConfigCommonSIB and this serving cell's (i.e., target Scell's) lowest SCS among all the configured SCSs in DL/UL SCS-SpecificCarrierList in ServingCellConfigCommon or ServingCellConfigCommonSIB).)
Below is an example of ASN.1.

| | |
|---|---|
| CSI-RS-CellMobility ::= | SEQUENCE { |
| cellId | PhysCellId, |
| csi-rs-MeasurementBW | SEQUENCE { |
| nrofPRBs | ENUMERATED { size24, size48, size96, size192, |

size264},

| | |
|---|---|
| startPRB | INTEGER(0..2169) |

},

| | |
|---|---|
| density | ENUMERATED {d1,d3} |

OPTIONAL, -- Need R

| | |
|---|---|
| csi-rs-ResourceList-Mobility | SEQUENCE (SIZE (1..maxNrofCSI-RS-ResourcesRRM)) OF |

CSI-RS-Resource-Mobility

| | |
|---|---|
| timeSyncSource | TimeSyncSource |

}

| | |
|---|---|
| TimeSyncSource ::= | SEQUENCE { |
| sourceCell | PCI (and ARFCN) or NCGI ( to be used for any CSI-RS |

resource without associatedSSB field)

| | |
|---|---|
| slotOffset | ca-SlotOffset |

Sol 2-2: Alternatively, instead of being provided for each CSI-RS cell, non-serving cell information for a single time synchronization may include synchronization cell information for CSI-RS measurement of all CSI-RS cells. Similarly, if there is no associatedSSB information for each CSI-RS resource, a corresponding synchronization cell is referenced.
The time synchronization cell information may include a PCI of the cell and/or a DL frequency of the cell, i.e., ARFCN and/or NCGI information, for recognizing the cell.
The time synchronization cell information may include information indicating, at a slot level, a time difference between the time synchronization cell and the CSI-RS transmission cell. Here, a slot offset is a time mismatch value at frame boundary misalignment in inter-band carrier aggregation where slots are aligned and SFNs are partially aligned, and includes a slot offset between the synchronization source cell and the CSI-RS cell. (Slot offset between the synch source cell and the CSI-RS Cell in unaligned frame boundary with slot alignment and partial SFN alignment inter-band CA)

Below is an example of ASN.1.

| | |
|---|---|
| CSI-RS-ResourceConfigMobility ::= | SEQUENCE { |
| subcarrierSpacing | SubcarrierSpacing, |
| csi-RS-CellList-Mobility | SEQUENCE (SIZE (1..maxNrofCSI-RS-CellsRRM)) OF CSI- |

RS-CellMobility,
...,

| | |
|---|---|
| timeSyncSource | TimeSyncSource |
| refServCellIndex | ServCellIndex |

OPTIONAL -- Need S
]]

| | |
|---|---|
| TimeSyncSource ::= | SEQUENCE { |
| sourceCell | PCI (and ARFCN) or NCGI ( to be used for any CSI-RS |

resource without associatedSSB field)

| | |
|---|---|
| slotOffset | ca-SlotOffset |

reportConfiguration
   RS type: needs to include an rs type of a CSI-RS.
When the UE receives a command to add an Scell from the network, time synchronization information of the Scell may be included in and received via a message including the command.
This time synchronization information may be one of the followings with respect to one of cells configured in a current cell group.
Indication of Spcell of the CellGroup (cell group targeted by a corresponding RRCReconfiguration message); or
Serving cell index of Scell if that Scell is already configured for the cell group (cell group targeted by the RRCReconfiguration message); or
Optionally, information the ca-offset value between the above “indicated source” and the Scell to be added (note that legacy also has ca slot offset value but between Pcell and the target Scell).
This time synchronization information may be a value including one of non-serving cells.
General cell identifier (identification info), such as CGI, PCI, and/or NR ARFCN12
Optionally, information on the ca-offset value between the above “indicated source” and the Scell to be added (note that legacy also has ca slot offset value but between Pcell and the target Scell).
If there is no separate cell indication, and the Scell to be added is included in a primary timing advance group (PTAG), a DL timing reference always uses Pcell. In addition, if the target Scell is included in a secondary timing advance group (STAG), the DL timing reference may be any activated Scell of the same TAG.
Among the options, instead of an Scell index, an indicator indicating the Spcell of the cell group may be included.
For a cell known as a synchronization (synch) source of an SSB-less Scell added according to the options, the UE may measure an SSB transmitted from the cell and reference time synchronization from the measured SSB, in order to perform time synchronization with a corresponding synch source reference cell. In addition, L3 RRM measurement of the SSB-less Scell may be replaced by measuring the SSB transmitted from the cell. L1 CSI measurement, CQI reporting, etc. may also be replaced.
After adding the SSB-less SCell, the UE may perform L1 and/or L3 measurement using a reference signal of the cell referenced as the synchronization (synch) source. In this case, if the reference cell is deactivated, a cell that performs measurement instead of the reference cell is required.
When L1 and/or L3 measurement for the SSB-less Scell is to be performed, the network may signal, in the following manner, the measurement and time/frequency synchronization reference cell of the SSB-less Scell, the reference cell transmitting the SSB to be measured.
Opt 1. An RRC message including an indicator for deactivating the synchronization reference cell of the SSB-less Scell may include a serving cell index for an alternative cell of the synchronization reference cell.
The UE having received the RRC message deactivates the specified synchronization reference cell. Accordingly, CSI measurement and reporting and/or L3 RRM measurement based on the deactivated cell may be stopped.
The UE having received the RRC message may perform time synchronization using an SSB of a serving cell indicated as the alternative cell, and perform CSI measurement and reporting and/or L3 RRM measurement and reporting.
There may be multiple serving cell indexes of alternative cells in the RRC message. In this case, the UE may replace the reference cell with any of the currently activated cells.
Opt 2. A DL MAC CE or DCI including a deactivation command for the synchronization reference cell of the SSB-less Scell may include a serving cell index of an alternative reference cell.
The UE having received the DL MAC CE or DCI deactivates the specified synchronization reference cell. Accordingly, CSI measurement and reporting and/or L3 RRM measurement based on the deactivated cell may be stopped.
   The UE having received the RRC message may perform time synchronization using an SSB of a serving cell indicated as the alternative cell, and perform CSI measurement and reporting and/or L3 RRM measurement and reporting.
There may be multiple serving cell indexes of alternative cells in the DL MAC CE or DCI. In this case, the UE may replace the reference cell with any of the currently activated cells.
Opt 3. An RRCReconfiguration message for configuring addition of the SSB-less Scell may include the current synchronization reference cell and a list of serving cell indexes of cells that may replace the synchronization reference cell upon its deactivation.

The UE having received the RRCReconfiguration message adds the SSB-less Scell, performs time/frequency synchronization based on the synchronization reference cell, performs L1 measurement and reporting based on SSB, and performs L3 radio resource management (RRM) measurement and reporting. Afterward, if the synchronization reference cell is deactivated, the synchronization reference cell may be replaced with any of the currently activated serving cells among the remaining cells corresponding to the list of serving cell indexes.
In the options, an Spcell of a corresponding cell group may serve as the reference cell, instead of using serving cell indexes for an alternative reference cell list. A 1-bit indicator indicating this may be included in the alternative reference cell list.

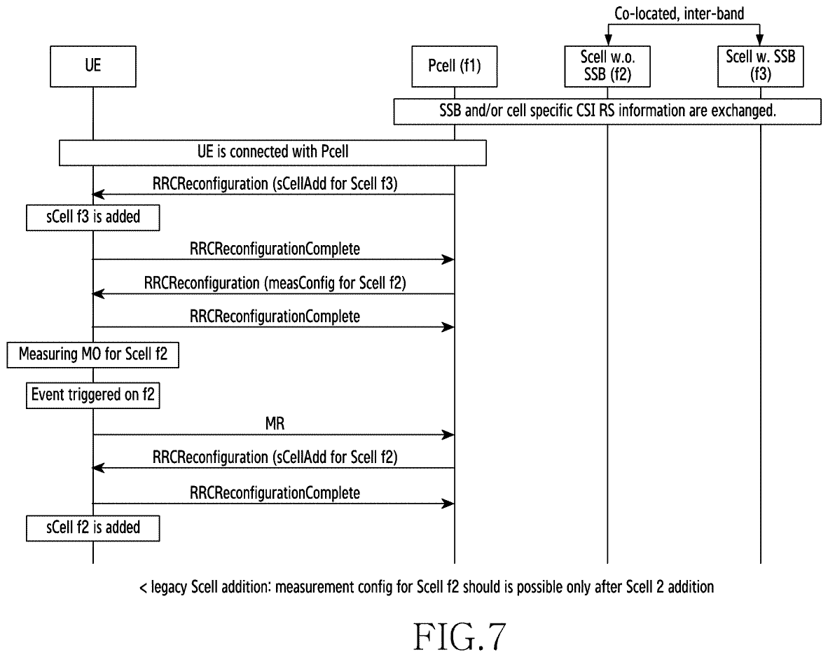

FIG. 7 is a diagram illustrating a method of adding an SSB-less Scell.

A UE maintains a connected state with a Pcell.

Afterward, in order to add a serving cell existing at frequency f3, the UE performs cell addition via an RRCReconfiguration message. Then, the UE adds Scell f3. The network is to add an f2 cell as an Scell for a CA operation. Here, f2 refers to frequency f2. In addition, this Scell f2 is assumed to be a cell which does not transmit an SSB.

For Scell f2 measurement, the network may configure a measurement object (MO) corresponding to f2, as a measurement configuration, in a subsequent RRCReconfiguration message and transfer the same to the UE. In this case, CSI-RS information of the MO, as a reference signal for measurement, may be included, and accordingly, an rs type of a report configuration may indicate a CSI-RS.

When CSI-RS resource information of a cell transmitting the CSI-RS, i.e. Scell f2, is included in the CSI-RS information of the MO, and an associatedSSB field is marked as absent, time synchronization of the CSI-RS references a refServCellIndex field existing in a CSI-RS-ResourceConfigMobility field of the MO. This field may indicate only one of serving cells. In FIG. 7, Scell f3 that is one of existing serving cells is assumed to be indicated.

According to this measurement configuration, when measuring Scell f2, the UE may perform time synchronization with Scell f3 and measure the CSI-RS transmitted from Scell f2. While performing measurement in this way, if a given event is satisfied, the UE may transmit a measurement report to the network. Based on this, the network may configure to add Scell f2 as an Scell.

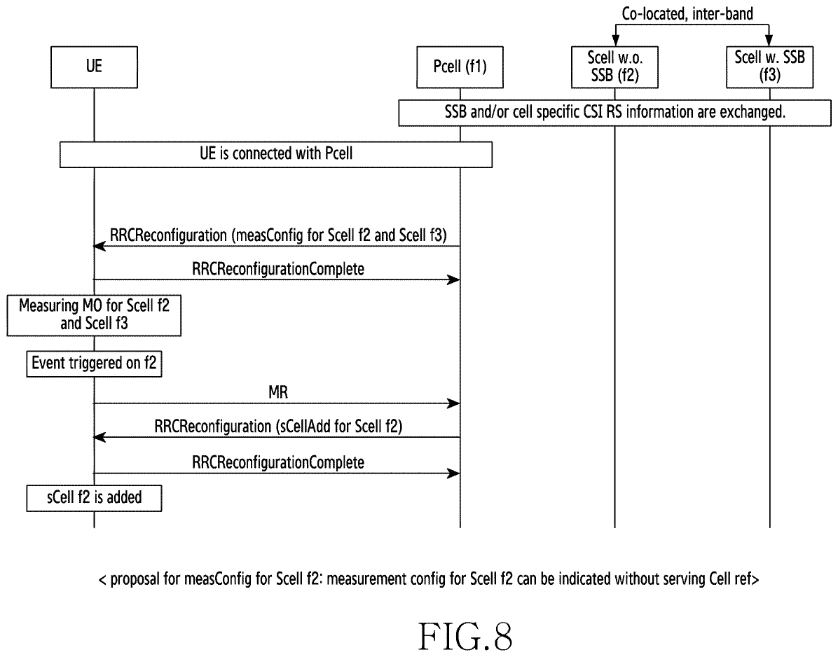

FIG. 8 is a diagram illustrating a method of performing time synchronization for an SSB-less Scell by using a non-serving cell when adding the SSB-less Scell according to an embodiment of the disclosure.

A UE may maintain a connected state with a Pcell.

Afterward, the network requests the UE to measure all cells of all possible frequencies, so as to receive a report when a desired event occurs. Accordingly, an MO and report config are configured for Scell f3. In addition, an MO and report config are configured for Scell f2. Scell f3 is transmitting an SSB, so that an RS type in report config indicates SSB. In addition, the MO also needs to include, as measurement RS information, SSB-based measurement timing configuration (SMTC) information including the SSB of Scell f3. Scell f2 is not transmitting an SSB, and thus transmits a cell-specific CSI-RS. Accordingly, cell-specific CSI-RSs transmitted from other cells at f2, which include Scell f2, should be included as measurement signals in the MO. In addition, the RS type in reportConfig should indicate CSI-RS. For the MO, when CSI-RS information for each of multiple cells is included, Scell f2 may indicate Scell f3 as a time synchronization reference cell for a CSI-RS. In this case, since Scell f3 has not yet been added as a serving cell, PCI and ARFCN information or NR CGI information may be included instead.

Based on this information, the UE may perform RRM measurement of f3 and f2. Afterward, when a specific event is satisfied and a measurement report is thus transmitted to the network, the network may issue, based on corresponding information, a command to add Scell f2 as an Scell.

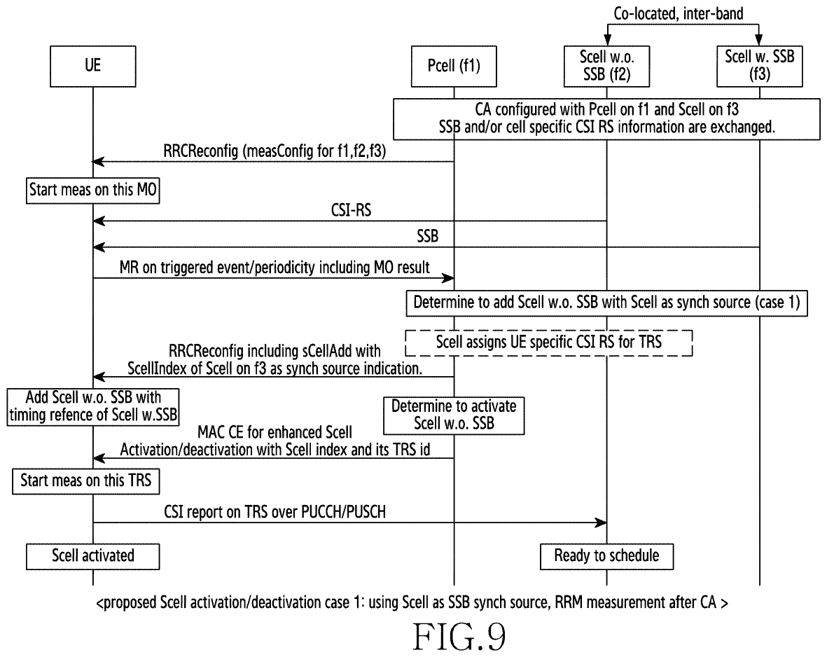

FIG. 9 is a diagram illustrating a method of using information on a serving cell as measurement information of an SSB-less Scell and using an index on the serving cell when adding the SSB-less Scell according to an embodiment of the disclosure.

Currently, a UE is in a connected state and has added a PCell and Scell f3. Afterward, measurement configuration information may be transferred to the UE. MO and reportConfig information for each frequency f1, f2, f3 may be as follows.

measId1: servingCellMO, MO1 (ssbFreq : f1, ssbSCS, smtc1, ssb-ConfigMobility ) ,
reportConfig1 (rsType:SSB)
measId2: MO2 (refFreqCSI-RS: f2's Point A value, csi-rs-ResourceConfigMobility(SCS:SCS for
f2cell, cell mobility: PCI for Scellf2, measBW,density,CSI-RS-resource list (cell specific CSI-RS
resource ID, no associatedSSB), refServCellIndex=servCellIndex for Scellf3, ca-slotoffset),
reportConfig2(rsType: CSI-RS)
measId3: servingCellMO, MO3 (ssbFreq:f3, ssbSCS, smtc1, ssb-ConfigMobility),
reportConfi3 (rsType:SSB)

measId1 may be servingCellMO for a Pcell.
measId 1 is a pair of MO1 and reportConfig 1.
   MO1 may include the following. (ssbFreq: f1, ssbSCS, smtc1, ssb-ConfigMobility)
   reportConfig1 may include the following. (rsType: SSB)
measId2 is information for measuring Scell f2.
measId2 is a pair of MO2 and reportConfig 2.
   MO2 may include the following. (refFreqCSI-RS: f2's Point A value, csi-rs-ResourceConfigMobility (SCS: SCS for f2cell, cell mobility: PCI for Scellf2, measBW, density, CSI-RS-resource list (cell specific CSI-RS resource ID, no associatedSSB), refServCellIndex=servCellIndex for Scellf
reportConfig2 may include the following. (rsType: CSI-RS)
measId3 may be servingCellMO for Scell f3.
measId3 is a pair of MO3 and reportConfig3.
   MO3 may include the following. (ssbFreq: f3, ssbSCS, smtc1, ssb-ConfigMobility)
   Reportconfig3 may include the following. (rsType: SSB)

When this information is included in an RRCReconfiguration message and transferred to the UE, the UE performs measurement for each frequency. In this case, for Scell f2 of f2, measurement is performed based on a CSI-RS, and time synchronization for the CSI-RS at that time is achieved based on a serving cell index of Scell f3 that has already been added. In addition, if ca-slotoffset is included, a time given in a slot may be additionally corrected based on a value thereof.

After performing measurement via this measurement configuration, the UE may transfer a measurement report to the network when a specific event is satisfied. Based on this measurement result, the network may be configured to add Scell f2 as an Scell. To this end, the network may include an sCellAddition field in the RRCReconfiguration message, and may include the serving cell index of Scell f3 in a timing reference source indicator without an absoluteFrequencySSB field of a frequencyInfoDL field of the Scell. In this case, the ca-slotoffset value may be included as needed.

When the UE receives the RRCReconfiguration message, time synchronization of added Scell f2 is performed based on given Scell f3 from then on.

1. UE is configured of CA with Pcell on f1 and Scell on f3. SSB and/or cell specific CSI-RS on each neighboring cell are exchanged.

2. Pcell and/or Scell on f3 (CA case in step 1) can transmit RRCReconfiguration msg including measurement configuration on MO for Scell without SSB on f2 with cell-specific CSI-RS config (with ca-slotOffset) and MO for Scell on f3 with SSB config.

3. UE measures the indicated signal (CSI-RS on f2 or SSB on f3, or both if configured) and report the result if triggered to the network.

Up to above step, it is not mandatory for Scell addition, and it's NW implementation.

4. Network determined to add Scell without SSB i.e., Scell on f2 based on the reported result. Network can further configure CSI-RS for CSI report including TRS on Scell of f2.

5. RRCReconfiguration msg including configuration for addition of sCell on f2, which includes frequencyInfDL IE with no absoluteFrequencySSB, and timing reference source indicator of ScellIndex of Scell on f3, and possibly offset of slot to be shifted.

6. UE will add this Scell with the timing reference with Scell w. SSB. SFN and subframe boundary are aligned, and possibly offset difference of can be used based on Scell w. SSB timing.

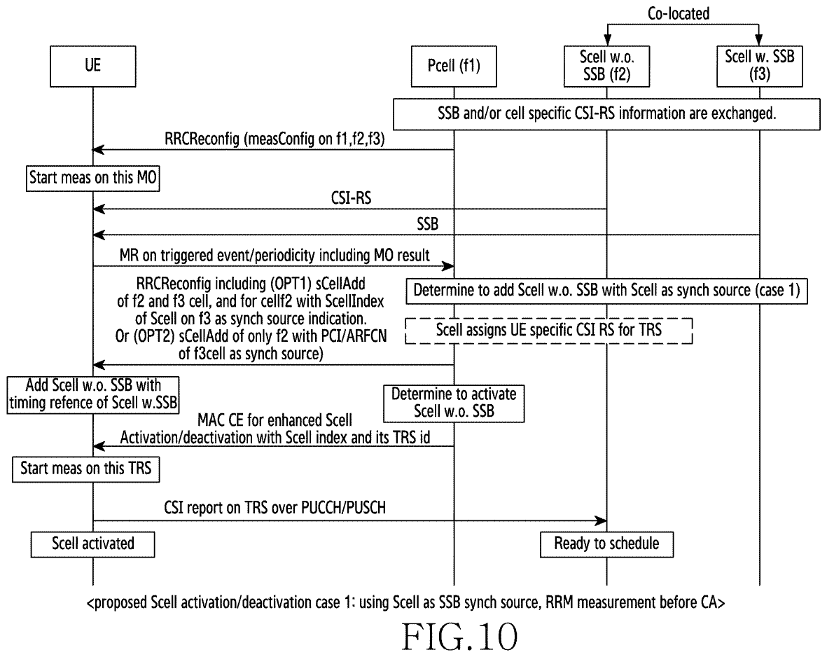

FIG. 10 is a diagram illustrating a method of using information on a non-serving cell as measurement information of an SSB-less Scell and using an index on a serving cell or information on the non-serving cell when adding the SSB-less Scell according to an embodiment of the disclosure.

Currently, a UE is in a connected state and has added only a Pcell. Afterward, measurement configuration information may be transferred to the UE. MO and reportConfig information for each frequency f1, f2, or f3 may be as follows.

measId1: servingCellMO, MO1 ( ssbFreq : f1, ssbSCS, smtc1, ssb-ConfigMobility ) ,
reportConfig1 (rsType:SSB)
measId2: MO2 (refFreqCSI-RS: f2's Point A value, for csi-rs-ResourceConfigMobility(SCS:SCS for
f2cell, cell mobility: PCI for Scellf2, measBW,density,CSI-RS-resource list (cell specific CSI-RS
resource ID, no associatedSSB), refCell=PCI and Freq Scellf3, ca-slotoffset),
reportConfig2(rsType: CSI-RS)
measId3: MO3( ssbFreq:f3, ssbSCS, smtc1, ssb-ConfigMobility), reportConfig3 (rsType:SSB)

measId1 may be servingCellMO for the Pcell.
measId 1 is a pair of MO1 and reportConfig 1.
   MO1 may include the following. (ssbFreq: f1, ssbSCS, smtc1, ssb-ConfigMobility)
   reportConfig1 may include the following. (rsType: SSB)
measId2 is information for measuring Scell f2.
   measId2 is a pair of MO2 and reportConfig 2.
   MO2 may include the following. (refFreqCSI-RS: f2's Point A value, csi-rs-ResourceConfigMobility (SCS: SCS for f2cell, cell mobility: PCI for Scellf2, measBW, density, CSI-RS-resource list (cell specific CSI-RS resource ID, no associatedSSB), refCell=PCI and Frequency for Scell f3, ca-slotoffset))
reportConfig2 may include the following. (rsType: CSI-RS)
measId3 is information for measuring Scell f3.
measId3 is a pair of MO3 and reportConfig3.
   MO3 may include the following. (ssbFreq: f3, ssbSCS, smtc1, ssb-ConfigMobility)
   Reportconfig3 may include the following. (rsType: SSB)

When the network includes this information in an RRCReconfiguration message and transfers the same to the UE, the UE performs measurement for each frequency. In this case, for Scell f2 of f2, measurement is performed based on a CSI-RS, wherein, time synchronization for the CSI-RS at that time is achieved by measuring an SSB, which is transmitted from the cell, based on a PCI and frequency of Scell f3 that has not been added yet. In addition, if ca-slotoffset is included, a time synchronization difference between a reference cell (Scell f3) and a measurement target cell (scell f2) may be additionally corrected based on a value of ca-slotoffset by using an offset value given at a slot level.

After performing measurement via this measurement configuration, the UE may transfer a measurement report to the network when a specific event is satisfied. Based on this measurement result, the network may be configured to add Scell f2 as an Scell. To this end, the network may include an sCellAddition field in the RRCReconfiguration message, and may include the serving cell index of Scell f3 in a timing reference source indicator without an absoluteFrequencySSB field of a frequencyInfoDL field of the Scell. In this case, the ca-slotoffset value may be included as needed.

As another method, an sCellAddition field may be included, and PCI and ARFCN values of Scell f3 may be included in a timing reference source indicator without an absoluteFrequencySSB field of a frequencyInfoDL field of the Scell. It is apparent that the ca-slotoffset value may also be added in this case.

When the UE receives the RRCReconfiguration message, time synchronization of added Scell f2 is performed based on given Scell f3 from then on.

1. UE is not configured of CA with Pcell on f1 and Scell on f3. SSB and/or cell specific CSI-RS on each neighboring cell are exchanged.

2. Pcell can transmit RRCReconfiguration msg including measurement configuration on MO for Scell without SSB on f2 with cell-specific CSI-RS config with syncsource, and offset value, and on MO for Scell on f3 with SSB config.

3. UE measures the indicated signal (CSI-RS on f2 or SSB on f3, or both if configured) and report the result if triggered to the network.

Up to above step, it is not mandatory for Scell addition, and it's NW implementation.

4. Network determined to add Scell without SSB i.e., Scell on f2 based on the reported result. Network can further configure CSI-RS for CSI report including TRS on Scell of f2.

5. RRCReconfiguration msg including

(Opt 1) configuration for addition of sCell on f2 and f3, for f2 cell, which includes frequencyInfDL IE with no absoluteFrequencySSB, and timing reference source indicator of ScellIndex of Scell on f3, and possibly offset of slot to be shifted.

(Opt 2) configuration for addition of sCell on f2, for which includes frequencyInfoDL IE with no absoluteFrequencySSB, and timing reference source information of f3 cell with PCI/ARFCN and possibly offset of slot to be shifted.

Opt 1, and Opt 2. both can be possible for meas config.

6. UE will add this Scell with the timing reference with Scell w. SSB. SFN and subframe boundary are aligned, and possibly offset difference of can be used based on Scell w. SSB timing.

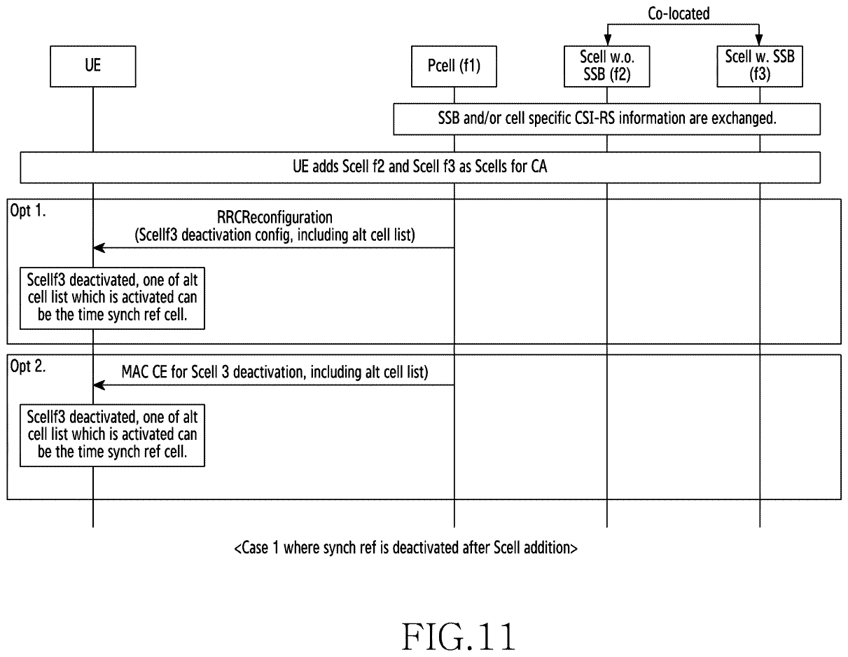

FIG. 11 is a diagram illustrating a method of transferring alternative cell information along with a deactivation RRC message or MAC CE when a synchronization reference is deactivated after adding an Scell according to an embodiment of the disclosure.

A UE has added a PCell, Scell f2, and Scell f3 as Scells.

In Opt 1, the network may deactivate Scell f3 via an RRCReconfiguration message, and may transfer alternative synch source cell list information along with the RRCReconfiguration message. The UE having received the RRCReconfiguration message may deactivate Scell f3 and concurrently select one of the currently activated cells from the transferred alternative cell list. If only one cell is indicated, and the cell is currently activated, the cell may be considered as a synch source.

In Opt 2, Scell f3 may be deactivated via a MAC CE, and the MAC CE may include alternative synch source cell information. The UE having received the MAC CE may deactivate Scell f3 and concurrently select one of the currently activated cells from the transferred alternative cell list. If only one cell is indicated, and the cell is currently activated, the cell may be considered as a synch source.

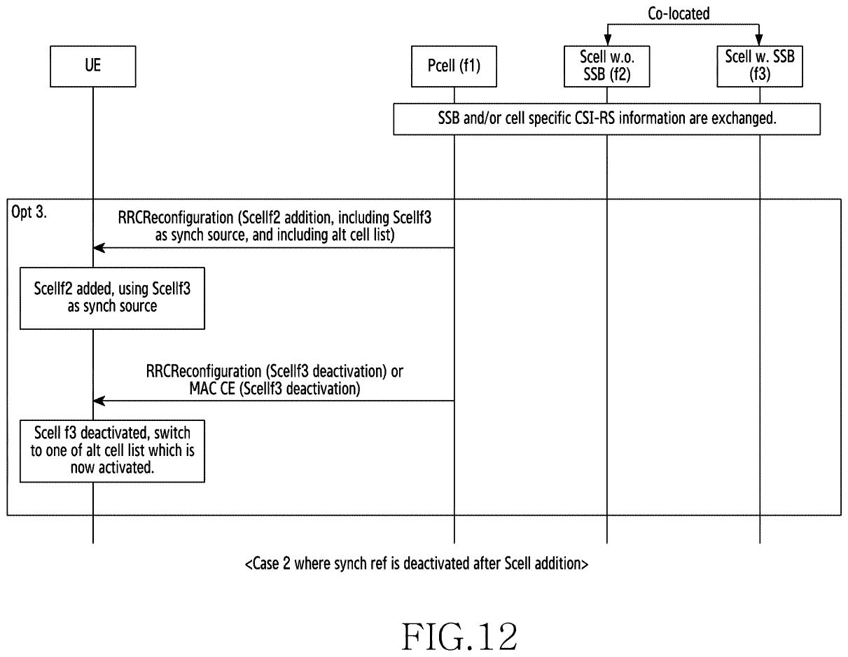

FIG. 12 is a diagram illustrating a method of transferring alternative synchronization source cell information simultaneously with Scell addition according to one embodiment of the disclosure.

A UE may configure to add Scell f2 via an RRCReconfiguration message in a state where only a PCell has been added. In this case, since Scell f2 is an SSB-less cell, non-serving cell identification information of Scell f3 or serving cell index information of Scell f3 may be included to indicate a synch source. In addition, if the synch source is deactivated, information on alternative synch source cells may be included in a list and transferred with the RRCReconfiguration message.

The UE having received the RRCReconfiguration message adds Scell f2 and considers Scell f3 as a synch source.

Afterward, if the network indicates deactivation of Scell f3 via RRCReconfiguration or MAC CE, the UE deactivates Scell f3 and considers, among the alternative cells received in the previous RRCReconfiguration message, the currently activated cell as an alternative cell and performs operation.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of a terminal in a wireless communication system, the method comprising:
receiving, from a base station, an RRC message comprising information indicating addition of a secondary cell (Scell) and downlink frequency information corresponding to the Scell;
identifying whether the downlink frequency information comprises a field indicating a reference cell for time synchronization of the Scell; and
in case that the downlink frequency information comprises the field indicating the reference cell, acquiring a timing reference of the Scell, based on the reference cell,
wherein the Scell is a synchronization signal block (SSB)-less Scell which does not transmit an SSB.

2. The method of claim 1, further comprising, in case that the downlink frequency information does not comprise the field indicating the reference cell, acquiring the timing reference of the Scell, based on a preconfigured cell.

3. The method of claim 1, wherein the Scell and the reference cell support inter-band carrier aggregation (CA).

4. The method of claim 1, wherein the reference cell comprises an Scell transmitting an SSB.

5. The method of claim 1, wherein the reference cell is included in the same cell group as the Scell.

6. A method of a base station in a wireless communication system, the method comprising:
identifying a reference cell for time synchronization of a secondary cell (Scell); and
transmitting, to a terminal, an RRC message comprising information indicating addition of the Scell and downlink frequency information corresponding to the Scell,
wherein the downlink frequency information comprises a field indicating the reference cell, and
wherein the Scell is a synchronization signal block (SSB)-less Scell which does not transmit an SSB.

7. The method of claim 6, wherein the Scell and the reference cell support inter-band carrier aggregation (CA).

8. The method of claim 6, wherein the reference cell is included in the same cell group as the Scell, and comprises an Scell transmitting an SSB.

9. A terminal in a wireless communication system, the terminal comprising:
a transceiver; and
a processor connected to the transceiver,
wherein the processor is configured to:
receive, from a base station, an RRC message comprising information indicating addition of a secondary cell (Scell) and downlink frequency information corresponding to the Scell;
identify whether the downlink frequency information comprises a field indicating a reference cell for time synchronization of the Scell; and
in case that the downlink frequency information comprises the field indicating the reference cell, acquire a timing reference of the Scell, based on the reference cell,
wherein the Scell is a synchronization signal block (SSB)-less Scell which does not transmit an SSB.

10. The terminal of claim 9, wherein the processor is configured to, in case that the downlink frequency information does not comprise the field indicating the reference cell, acquire the timing reference of the Scell, based on a preconfigured cell.

11. The terminal of claim 9, wherein the Scell and the reference cell support inter-band carrier aggregation (CA).

12. The terminal of claim 9, wherein the reference cell comprises an Scell transmitting an SSB.

13. A base station in a wireless communication system, the base station comprising:
a transceiver; and
a processor connected to the transceiver,
wherein the processor is configured to:
identify a reference cell for time synchronization of a secondary cell (Scell); and
transmit, to a terminal, an RRC message comprising information indicating addition of the Scell and downlink frequency information corresponding to the Scell,
wherein the downlink frequency information comprises a field indicating the reference cell, and
wherein the Scell is a synchronization signal block (SSB)-less Scell which does not transmit an SSB.

14. The base station of claim 13, wherein the Scell and the reference cell support inter-band carrier aggregation (CA).

15. The base station of claim 13, wherein the reference cell is included in the same cell group as the Scell, and comprises an Scell transmitting an SSB.
